(19) United States
(12) Patent Application Publication
(10) Pub. No.: US 2025/0011124 A1
(43) Pub. Date: Jan. 9, 2025

(54) CHAIN-INSTALL APPARATUS, SYSTEMS, AND METHODS

(71) Applicant: FREEPORT MINERALS CORPORATION, Phoenix, AZ (US)

(72) Inventors: Edward A. Peru, Solomon, AZ (US); Brennan Davik Varela, Morenci, AZ (US); Steve J. Owens, Jr., Safford, AZ (US); Ry G. Sayre, Morenci, AZ (US); Mark A. Rubalcava II, Safford, AZ (US)

(73) Assignee: FREEPORT MINERALS CORPORATION, Phoenix, AZ (US)

(21) Appl. No.: 18/347,331

(22) Filed: Jul. 5, 2023

(51) Int. Cl. B65H 49/22; B65H 49/34; B66C 1/10

(52) U.S. Cl. CPC B65H 49/22; B65H 49/34; B66C 1/10; B65H 2403/725; B65H 2701/3911

(57) ABSTRACT

A chain-install apparatus for facilitating installation of a chain into a conveyor system (e.g., a conveyor system for a cathode stripping machine) comprises: a support structure; a hub assembly coupled to the support structure, a brake assembly operably coupled to the hub assembly, and an attachment arrangement configured to facilitate lifting of the chain-install apparatus by a crane.

### FIELD

The present disclosure generally relates to chain-install apparatuses and systems, as well as methods of chain-installation. More particularly, the present disclosure generally relates to industrial chain-installation apparatuses and systems, as well as methods for safely installing a chain in an industrial machine.

### BACKGROUND

A cathode stripping machine is a type of industrial machine specially used for stripping of electro-refined copper cathode. The cathode stripping machine includes various components to facilitate the stripping of the copper cathode. In particular, a conveyor unit is typically utilized for transporting cathodes to be treated from an upstream region of a stripping device, through the stripping device, to a downstream storage area from the stripping device.

The conveyor unit for a cathode stripping machine typically include a pair of parallel chains. The pair of parallel chains are spaced apart in a lateral direction and can be configured to receive cathodes to be treated (or groups of cathodes to be treated). After prolonged use of the cathode stripping machine, chains of the conveyor unit can wear out or break. Accordingly, the chains have to be replaced at various intervals throughout a life cycle of a conveyor unit.

Typical process for installing chains on a conveyor unit for a cathode stripping machine are labor intensive and can result in various potential safety hazards, such as pinch points between chain links, lack of control over the chain during the installation process, lack of balance of the chain during the installation process, etc. Additionally, chains for use in cathode stripping machines are typically made of metal or a metal alloy, are long in length, and heavy, making them difficult to handle during installation and requiring significant time and personnel.

Although installing a chain from a starting point above a track receiving the chain may be desirable, devices, systems, and methods for installing the chain have typically included a starting point on the ground. In particular, since safety standards for lifting systems can be onerous, chain-install apparatuses and systems configured for lifting have been avoided in the art in favor of ground install systems via manual labor.

Accordingly, improved chain-install apparatuses and systems, as well as methods of installation may be desirable, and there has been a long felt, but unresolved need in the art for chain-install apparatuses and systems that can maneuver a chain above a track and facilitate installation of the chain in a controlled and safe manner.

### SUMMARY

Disclosed herein is a chain-install apparatus for facilitating installation of a chain into a conveyor system (e.g., a conveyor system for a cathode stripping machine). In various embodiments, the chain-install apparatus comprises: a support structure; a hub assembly coupled to the support structure, a brake assembly operably coupled to the hub assembly, and an attachment arrangement configured to facilitate lifting of the chain-install apparatus by a crane.

In various embodiments, the chain-install apparatus can comprise two of the hub assembly (e.g., disposed on opposite sides of a central column) and two of the brake assembly (e.g., each brake assembly operably coupled to a respective hub assembly). Accordingly, the chain-install apparatus can be configured to facilitate installation of a pair of chains into a respective conveyor system with a pair of tracks configured to receive the chains.

In various embodiments, a brake input of the brake assembly can be utilized to operate the brake assembly. In various embodiments, the brake input is coupled to a base of the chain-install apparatus. Accordingly, the brake assembly can be configured to be operated while the chain-install apparatus is in a lifted state.

In various embodiments, the brake assembly is a reverse brake assembly configured to transition between a default state that supplies a maximum brake force to a brake drum of the hub assembly to a released state that allows the hub assembly to spin freely. Accordingly, a rate of feed of a chain being installed from the chain-install apparatus can be controlled by the reverse brake assembly.

In various embodiments, a chain-install apparatus comprises a support structure, a hub assembly coupled to the support structure, a brake assembly operably coupled to the hub assembly, an attachment arrangement coupled to the support structure, and a chain that is winded around the hub assembly. In various embodiments, the chain-install apparatus is configured to facilitate installation of the chain into a conveyor system (e.g., a conveyor system for a cathode stripping machine).

Disclosed herein is a method of installing a chain (or chains) into a conveyor system (e.g., a conveyor system of a cathode stripping machine). In various embodiments, the method comprises lifting a chain-install apparatus, dispensing the chain by releasing a brake of the chain-install apparatus, and adjusting a rate of feed for the chain via a brake assembly during the installation.

Disclosed herein is a method for assembling a chain on a chain-install apparatus and transporting the chain-install apparatus. In various embodiments, the method comprises transitioning a brake assembly from a first state to a second state, coupling a first end of the chain to a hub assembly, winding the chain up on the hub assembly, transitioning the brake assembly from the second state to the first state, coupling a second end of the chain to the hub assembly to form a shipping configuration of the chain-install apparatus, and transporting the chain-install apparatus.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates a top-down view of a conveyor system for a cathode stripping machine, in accordance with various embodiments.

FIG. 2A illustrates a cross-sectional view of a portion of a chain in the conveyor system from FIG. 1, in accordance with various embodiments.

FIG. 2B illustrates a side view of the chain of FIG. 2A, in accordance with various embodiments.

FIG. 3A illustrates a perspective view of a chain-install apparatus for installing a chain into the conveyor system of FIG. 1, in accordance with various embodiments.

FIG. 3B illustrates a perspective view of the chain-install apparatus of FIG. 3A with a hub assembly removed for illustrative purposes, in accordance with various embodiments.

FIG. 4 illustrates a cross-sectional view of a hub assembly of the chain-install apparatus of FIG. 3A, in accordance with various embodiments.

FIG. 5 illustrates a perspective view of a portion of the chain-install apparatus, in accordance with various embodiments.

FIG. 6A illustrates a brake input of a brake assembly of a chain-install apparatus in a first position, in accordance with various embodiments.

FIG. 6B illustrates a brake input of a brake assembly of a chain-install apparatus in a second position, in accordance with various embodiments.

FIG. 6C illustrates a brake input of a brake assembly of a chain-install apparatus in a third position, in accordance with various embodiments.

FIG. 7 illustrates a method for installing a chain or chains into a conveyor system, in accordance with various embodiments.

FIG. 8A illustrates the chain-install apparatus during a step from the method of FIG. 7, in accordance with various embodiments.

FIG. 8B illustrates the chain-install apparatus during a step from the method of FIG. 7, in accordance with various embodiments.

FIG. 8C illustrates the chain-install apparatus during a step from the method of FIG. 7, in accordance with various embodiments.

FIG. 9 illustrates the chain-install apparatus during a step from the method of FIG. 7, in accordance with various embodiments.

FIG. 10 illustrates a method for using and transporting the chain-install apparatus, in accordance with various embodiments.

### DETAILED DESCRIPTION

The following detailed description of various embodiments herein refers to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

Disclosed herein is a chain-install apparatus configured to install a chain in a conveyor system (e.g., a conveyor system for a cathode stripping machine or the like). In various embodiments, the chain-install apparatus is configured to facilitate a controlled and/or balanced installation of a chain into a track to form a conveyor system. The chain-install apparatus is configured to be lifted (e.g., via a crane or the like). In this regard, the chain-install apparatus includes an attachment arrangement configured to form a suspension arrangement in response to coupling a crane to the attachment arrangement.

In various embodiments, the chain-install apparatus as disclosed herein is configured to comply with the standard set by the American Society of Mechanical Engineers (“ASME”) in 2018 in section b30.20, which is directed towards “Below-the Hook Lifting Devices.” In particular, installation of chains onto a track to form a conveyor system in industrial applications, such as for use in a cathode stripping machine can be performed by technicians, or other maintenance personnel, from a ground location or from a lifted location. Prior to the standard b30.20 being set by the ASME, chain-installation in conveyor systems for large industrial applications typically did not comply with the standard set in 2018.

After the standard was set, installation of chains in large industrial applications have mainly been performed without a below-the-hook lifting device to avoid having to comply with the standards set in section b30.20. Stated another way, after the standard was set in 2018, chains have been installed from the ground (e.g., either loosely by maintenance personnel or by a ground-based device). In this regard, since the standard was set, a chain-install apparatus capable of complying with the ASME standard b30.20 has yet to be developed. This could be due to a lack of interest, since the chain of the conveyor system can still be installed from a ground device, or while the chain is in a loose configuration. Alternatively, or additionally, this could be due to a lack of appreciation of the potential or marketability for a chain-install apparatus that is configured to comply with the ASME standard b30.20. In particular, the chain-install apparatus disclosed herein not only complies with the ASME standard b30.20, but further facilitates a simplified shipping process of the chain to be installed, a simplified method of maneuvering the chain toward a location to be installed, a simplified manner of lifting the chain, and/or a simplified installation process of the chain, in addition to the enhanced safety features from complying with the ASME standard b30.20, in accordance with various embodiments. Accordingly, the chain-install apparatus disclosed herein satisfies a long-felt, but unresolved need in the installation of chains in large industrial applications.

In various embodiments, the chain-install apparatus disclosed herein does not include a motor. In this regard, many spool devices for winding electrical cables include motors to wind and unwind electrical cables. This is because typical spool devices are not configured for installing electrical cables in another machine or device that interfaces with the electrical cables. In contrast to typical spool devices for winding electrical cables, the chain-install apparatus disclosed herein is configured to facilitate a controlled and balanced installation of a chain into a track that engages with the chain. Stated another way, the track that the chain engages with can include a motor to pull the chain during installation and facilitate the unwinding of the chain. Accordingly, the chain-install apparatus can be without a motor, and a motor of the track can be utilized to facilitate an ease of installation of the chain, in accordance with various embodiments.

During the installation of the chain, a rate of feed of the chain can be controlled by a brake assembly of the chain-install apparatus. In this regard, if an engagement between a chain link segment and a corresponding element of the track is missed, the brake assembly can be transitioned to a default position that is configured to supply a maximum brake force to a hub assembly of the chain-install apparatus to pause the installation process and remedy the missed engagement.

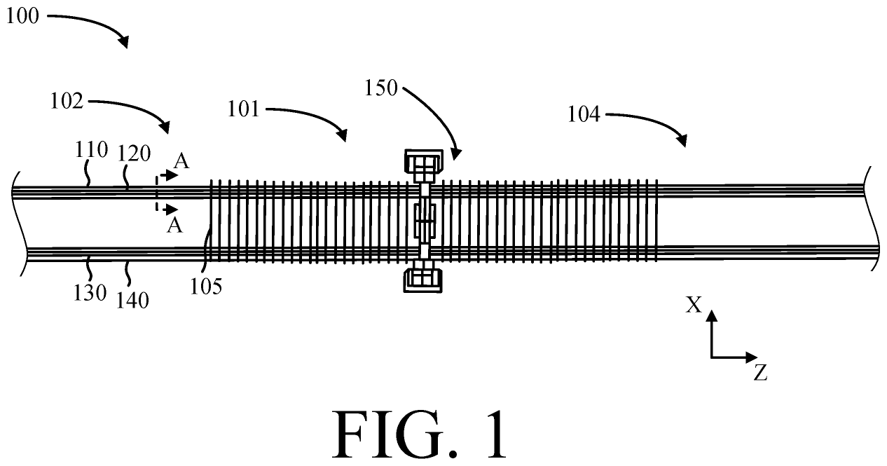

Referring now to FIG. 1, a top-down view of a cathode stripping machine 100 is illustrated, in accordance with various embodiments. The cathode stripping machine 100 includes a conveyor system 101 including a first chain 110 installed on a first track 120 spaced apart laterally (i.e., a X-direction) from a second chain 130 installed on a second track 140. As described further herein, the first chain 110 and the second chain 130 can each be installed on their respective track (e.g., first track 120 for first chain 110 and second track 140 for second chain 130) by a chain-install system with a chain-install apparatus. In various embodiments, the first chain 110 and the second chain 130 each define a longitudinal axis. The longitudinal axis defined by the first chain 110 is parallel to the longitudinal axis defined by the second chain 130 (i.e., in the Z-direction). In this regard, the conveyor system 101 is configured (i.e., operable) to translate in the longitudinal direction (i.e., the Z-direction) for transporting cathodes that are loaded in an upstream conveyor region 102, transported through a treatment device 150, and output to a downstream storage region 104. For example, the conveyor system 101 can include a drive system (e.g., a sprocket with a motor) configured to drive the chains 110, 130. The chains 110, 130 can be guided within their respective tracks 120, 140 as the chains 110, 130 are driven by the drive system (e.g., chains 110, 130 being engaged with a respective sprocket for each chain).

In various embodiments, as described further herein, the chains 110, 130 are further configured to engage (or hold) the cathodes 105 during operation of the cathode stripping machine 100. Stated another way, the chains 110, 130 can include protrusions with notches that are configured to engage (or hold) a cathode 105 during operation of the cathode stripping machine 100, as described further herein.

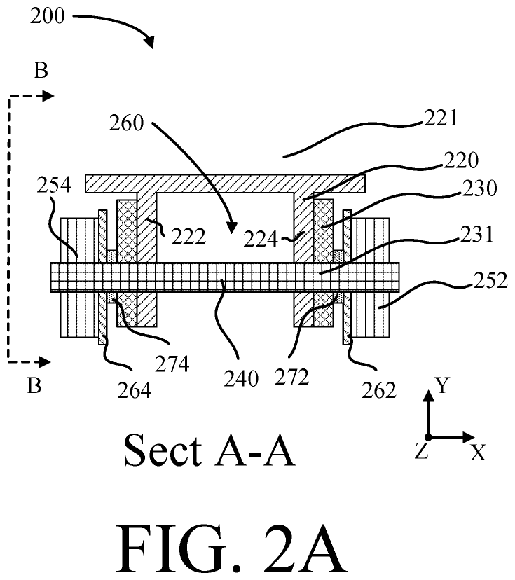

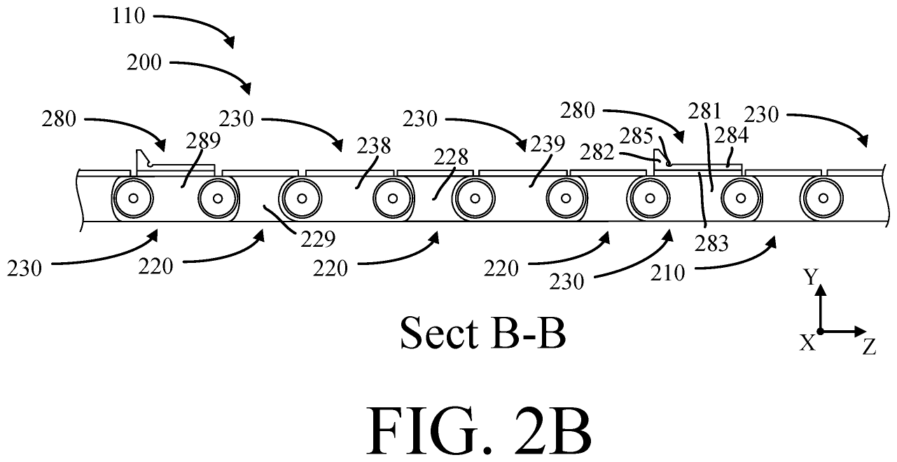

With reference now to FIGS. 2A and 2B, a cross-sectional view along section line A-A from FIG. 1 (FIG. 2A), and a cross-sectional view along section line B-B from FIG. 2A (FIG. 2B) of a chain 200 (e.g., first chain 110 and/or second chain 130 for use in the cathode stripping machine 100 from FIG. 1) are illustrated, in accordance with various embodiments. In various embodiments, the chain 200 comprises a plurality of chain link segments 210 including a set of inner chain link segments 220 and a set of outer chain link segments 230. Each chain link segment in the set of inner chain link segments 220 is coupled to an outer chain link segment in the set of outer chain link segments 230. For example, the inner chain link segment 221 is coupled to the outer chain link segment 231 (e.g., via a pin 240 and nuts 252, 254).

In various embodiments, each coupling between adjacent chain link segments in the plurality of chain link segments 210 can include a wheel assembly 260. In this regard, the chain 200 can be configured to roll along a track (e.g., first track 120 or second track 140 of the conveyor system 101) during operation of the cathode stripping machine 100 from FIG. 1, in accordance with various embodiments. Although illustrated as including a wheel assembly, 260, the present disclosure is not limited in this regard. For example, the chain 200 can be configured to slide along the track (e.g., first track 120 or second track 140 of the conveyor system 101 from FIG. 1) and still be within the scope of this disclosure. In various embodiments, the wheel assembly 260 includes wheels 262, 264, bushings 272, 274, pin 240 and nuts 252, 254. In this regard, the wheels 262, 264 are configured to rotate with the pin 240 and the nuts 252, 254 during operation of the cathode stripping machine 100 to facilitate translation of the cathodes 105 through the treatment device 150 from FIG. 1, in accordance with various embodiments. Although illustrated with wheels 262, 264, the present disclosure is not limited in this regard. For example, a single wheel disposed between the sidewalls 222, 224 of an inner chain link segment in the set of inner chain link segments 220 is also within the scope of this disclosure. However, by having the wheels 262, 264 disposed outward from a central vertical plane through the chain link segment (i.e., a Y-Z plane), the pin 240 can engage teeth of a sprocket to drive the chain 200, in accordance with various embodiments. Although the pin 240 is illustrated as a solid bearing pin, the present disclosure is not limited in this regard. For example, each chain link segment in the plurality of chain link segments 210 can be coupled to an adjacent chain link segment in the plurality of chain link segments by a hollow bearing pin or a deep link, and still be within the scope of this disclosure. In various embodiments, a solid bearing pin can provide greater strength relative to a hollow bearing pin or a deep link, which can be beneficial for large industrial applications, such as for use in the cathode stripping machine 100 from FIG. 1.

In various embodiments, the chain comprises a set of attachment chain link segments 280. Although illustrated as being in the set of outer chain link segments 230, the present disclosure is not limited in this regard. For example, attachment chain link segments in the set of attachment chain link segments 280 can be in the set of inner chain link segments 220 and/or in the set of outer chain link segments 230. In various embodiments, each attachment chain link segment in the set of attachment chain link segments includes an attachment protrusion extending vertically from a body of the attachment chain link segment. For example, the attachment chain link segment 281 comprises a protrusion 282 extending upward (e.g., in a Y-direction) from a top plate 284. The top plate 284 can be configured to interface with an intermediate plate 283 of the attachment chain link segment 281. The attachment chain link segment 281 can further comprise a notch 285 defined between the protrusion 282 and the top plate 284. In this regard, the attachment chain link segment 281 can be configured to engage (or hold) a cathode (e.g., cathode 105) to be treated by the treatment device 150 of the cathode stripping machine 100 from FIG. 1. Although illustrated with the protrusion 282, the top plate 284, and the notch 285, the present disclosure is not limited in this regard. For example, various engagement mechanisms configured to engage, hold, or secure a cathode (e.g., cathode 105) to be treated by the treatment device 150 of the cathode stripping machine 100 from FIG. 1 will be readily apparent to one skilled in the art.

In various embodiments, each attachment chain link segment is separated from an adjacent attachment chain link segment by a set of chain link segments in the plurality of chain link segments. For example, the attachment chain link segment 281 in the set of attachment chain link segments 280 is separated by the attachment chain link segment 289 in the set of attachment chain link segment 289 by five chain link segments in the plurality of chain link segments 210. Although illustrated as being separated by five chain link segments, the present disclosure is not limited in this regard. The spacing between attachment chain link segments in the set of attachment chain link segments 280 facilitates a spacing between cathodes (e.g., cathodes 105) during treatment by the treatment device 150 from FIG. 1. Accordingly, any spacing between attachment chain link segments in the set of attachment chain link segments 280 is within the scope of this disclosure.

In various embodiments, the chain alternates between inner chain link segments in the set of inner chain link segments 220 and outer chain link segments in the set of outer chain link segments 230. For example, each inner chain link segment can be coupled to an outer chain link segment at a first longitudinal end and an outer chain link segment at a second longitudinal end. Accordingly, a first inner chain link segment 228 in the set of inner chain link segments 220 is configured to couple (e.g., via wheel assembly 260) to a first outer chain link segment 238 in the set of outer chain link segments 230 at a first longitudinal end and a second outer chain link 239 segment in the set of outer chain link segments 230 at a second longitudinal end. Similarly, the first outer chain link segment 238 in the set of outer chain link segments 230 is configured to couple (e.g., via the wheel assembly 260) to a second inner chain link segment 229 in the set of inner chain link segments 220 at a third longitudinal end. In this regard, the first longitudinal end is between the second longitudinal end and the third longitudinal end.

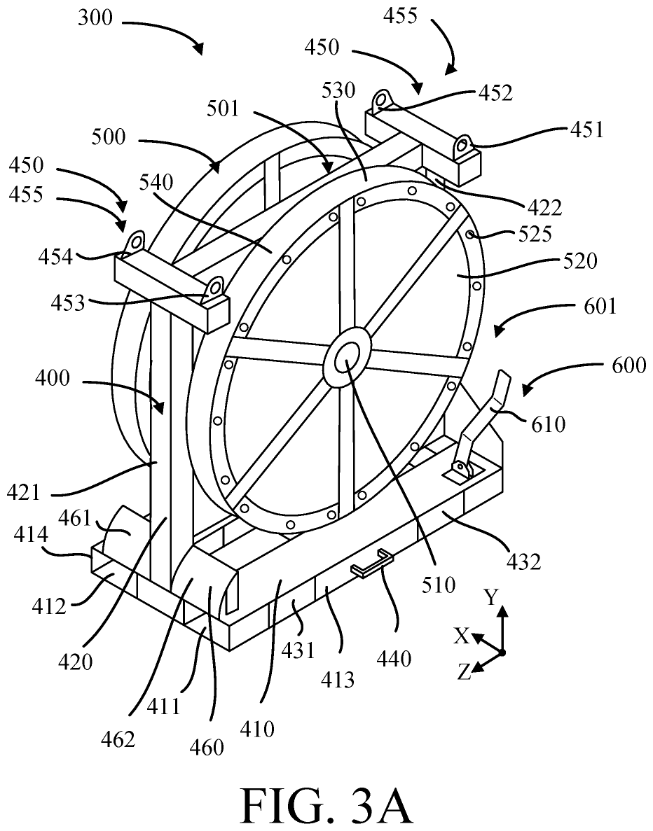

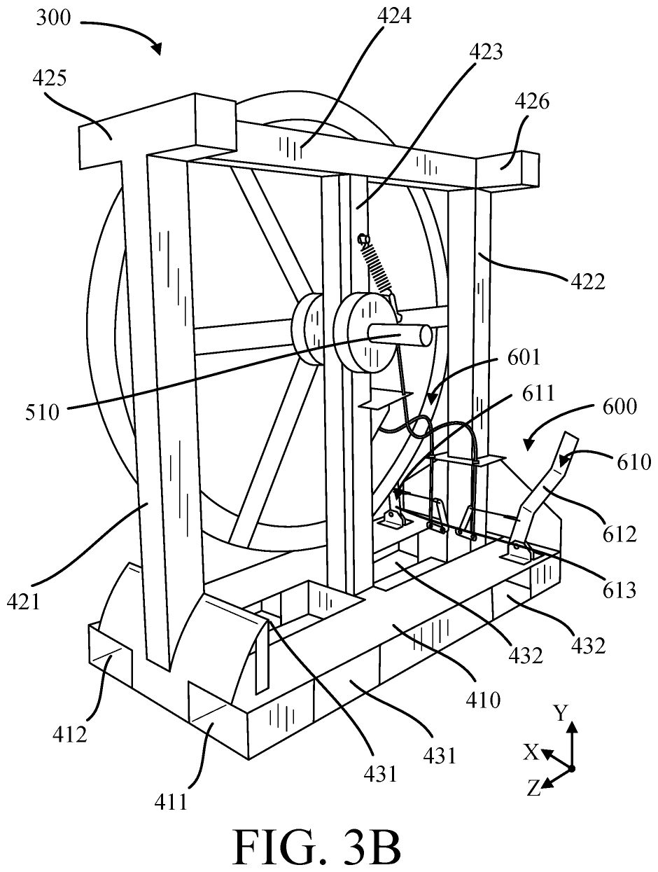

Referring now to FIG. 3A, a perspective view of a chain-install apparatus 300 for use in installing a chain (e.g., chain 200 from FIG. 2) into a conveyor system (e.g., conveyor system 101 of a cathode stripping machine 100 from FIG. 1 or any other industrial application), is illustrated, in accordance with various embodiments. In various embodiments, as described further herein, the chain-install apparatus 300 is configured to facilitate installation of a chain (e.g., installation of chain 200 from FIG. 2) into a conveyor system (e.g., conveyor system 101 from FIG. 1) in a balanced and controlled manner. In various embodiments, the chain-install apparatus 300 can be configured to protect mechanics during the installation process. In various embodiments, the chain-install apparatus 300 is configured for ease of transportation. For example, the chain-install apparatus 300 can be configured to be transported throughout a manufacturing facility to facilitate shipment of the chain-install apparatus 300 to an installation location, the chain-install apparatus 300 can be configured to be transported throughout a production plant prior to installation of a chain, the chain-install apparatus 300 can be configured to be lifted prior to installation of the chain (e.g., via a crane or the like), in accordance with various embodiments.

The chain-install apparatus 300 comprises a support structure 400, a hub assembly 500, a brake assembly 600, and an attachment arrangement 450. In various embodiments, the chain-install apparatus 300 further comprises a second hub assembly (e.g., hub assembly 501). However, although illustrated as including two hub assemblies (e.g., the hub assembly 500 and the hub assembly 501), the present disclosure is not limited in this regard. For example, a chain-install apparatus 300 having only a single hub assembly (e.g., hub assembly 500 or hub assembly 501), or more than two hub assemblies are within the scope of this disclosure. Yet, with two hub assemblies (e.g., the hub assembly 500 and the hub assembly 501), the chain-install apparatus 300 can facilitate installation of parallel chains of a conveyor system (e.g., conveyor system 101 of cathode stripping machine 100 from FIG. 1) in an efficient and safe manner, as described further herein, in accordance with various embodiments. For example, a first chain (e.g., in accordance with the chain 200 from FIG. 2) and a second chain (e.g., in accordance with the chain 200 from FIG. 2) can be installed while the chain-install apparatus 300 is in a lifted state over the tracks 120, 140 to form the first chain 110 and the second chain 130 of the conveyor system 101 from FIG. 1 without having to set a first chain-install apparatus down and lift a new chain-install apparatus, in accordance with various embodiments.

In various embodiments, a hub assembly (e.g., hub assembly 500 and/or hub assembly 501) is coupled to the frame 420 of the support structure 400). The hub assembly 500 (and/or hub assembly 501) includes a shaft 510, a first guard 520 coupled to the shaft 510, and a second guard 530 coupled to the shaft 510. The first guard 520 is spaced apart from the second guard 530 laterally (i.e., in the X-direction) from the second guard 530 and at least partially defines a pocket 540 (e.g., a radial pocket) therebetween. In this regard, the hub assembly (e.g., hub assembly 500 and/or hub assembly 501) is configured to have a chain (e.g., chain 200 from FIG. 2) winded thereon (e.g., within the pocket 540) for transportation of the chain to an installation location (e.g., a production facility with a cathode stripping machine 100 from FIG. 1). The hub assembly (e.g., hub assembly 500 and/or hub assembly 501) can further be configured to protect an operator (e.g., an individual installing the chain winded thereon) by limiting access to an end the chain that is being installed. Stated another way, the portion of the chain that is winded around a shaft in the hub assembly (e.g., hub assembly 500 and/or hub assembly 501) during installation of the respective chain (e.g., chain 200 from FIG. 2), may be inaccessible to the operator (e.g., due to the guards 520, 530) to prevent injuries (e.g., due to pinch points or the like), in accordance with various embodiments.

In various embodiments, one of the first guard 520 or the second guard 530 can comprise a plurality of apertures 525, each aperture in the plurality of apertures 525 spaced apart circumferentially from an adjacent aperture in the plurality of apertures 525. In this regard, prior to shipment of the chain-install apparatus 300 having a chain (e.g., chain 200 from FIGS. 2A and 2B) that is winded thereon, an end of the chain can be coupled to the respective guard (e.g., first guard 520 or the second guard 530) that has the plurality of apertures 525 disposed therethrough. Stated another way, a fastener (e.g., a bolt) can be disposed through an aperture in the plurality of apertures 525 and a nut can be coupled to the fastener to couple the chain to the guard. By having the end of the chain coupled to the guard (e.g., first guard 520 or second guard 530) prior to shipping of the chain-install apparatus, accidental unwinding of the chain during shipment can be prevented, in accordance with various embodiments.

In various embodiments, a brake assembly is operably coupled to the hub assembly (e.g., brake assembly 600 is operably coupled to the hub assembly 500 and/or brake assembly 601 is operably coupled to hub assembly 501). In this regard, a rate of feed for a chain (e.g., chain 200 from FIGS. 2A and 2B winded within the pocket 540 of the hub assembly 500) can be controlled by the brake assembly 600 operably coupled thereto during installation of the chain into a conveyor system (e.g., conveyor system 101 of the cathode stripping machine 100 from FIG. 1).

In various embodiments, an attachment arrangement 450 is coupled to the support structure 400. The attachment arrangement 450 can be configured to form a suspension arrangement in response to being coupled to a crane as described further herein. In this regard, the attachment arrangement 450 is configured to facilitate transitioning of the chain-install apparatus 300 from a fixed state on a ground surface to a lifted state above the ground surface, as described further herein. The attachment arrangement 450 can be configured to facilitate lifting of a heavy load. For example, with a chain winded on each hub assembly (e.g., hub assembly 500 and hub assembly 501) prior to installation of each chain, the chain-install apparatus 300 could way up to approximately 2,325 lbs. (1,055 kg). Accordingly, a spacing arrangement of the attachment arrangement between attachment points (e.g., lifting lugs 451, 452, 453, 454) can be configured to facilitate a safe, smooth, and balanced lifting of the chain-install apparatus 300 via a crane, as described further herein. For example, the attachment arrangement 450 includes a plurality of lifting lugs 455 coupled to atop side of the frame 420 (e.g., atop surface of beam 424 and atop surface of beam 426). In this regard, the attachment arrangement 450 can be configured to be coupled to a below the hook lifting device, such as a crane, as described previously herein.

In various embodiments, the plurality of lifting lugs 455 can include lifting lug 451 spaced apart laterally (i.e., in the X-direction) from the lifting lug 452. The lifting lugs 451, 452 can be disposed proximate a first longitudinal end of the chain-install apparatus. Similarly, the plurality of lifting lugs 455 can include lifting lug 453 spaced apart laterally (i.e., in the X-direction) from the lifting lug 454. The lifting lugs 453, 454 can be disposed proximate a second longitudinal end of the chain-install apparatus 300. The second longitudinal end of the chain-install apparatus can is spaced apart longitudinally (i.e., in the Z-direction) form the first longitudinal end. In various embodiments, the lifting lug arrangement can define a rectangular arrangement. Stated another way, a rectangle can be formed by connecting each center point of each aperture disposed through a respective lifting lug to an adjacent lateral lifting lug and an adjacent longitudinal lifting lug. For example, by connecting a center point defined by an aperture of lifting lug 451 to a center point defined by an aperture of lifting lug 452 and a center point defined by an aperture of lifting lug 453 and connecting a center point defined by an aperture of lifting lug 454 to the center point of the aperture of lifting lug 452 and the center point defined by the aperture of lifting lug 453, a rectangle can be defined. Although described and illustrated herein as including a rectangular arrangement for the attachment arrangement, the present disclosure is not limited in this regard. For example, the plurality of lifting lugs can form a diamond arrangement, a triangular arrangement, or any other arrangement known in the crane lifting arts and be within the scope of this disclosure. In various embodiments, by having a rectangular arrangement, the chain-install apparatus 300 can remain relatively balanced during lifting of the chain-install apparatus and/or remain balanced while in the lifting state during installation of the chain (e.g., during installation of chain 200 from FIGS. 2A and 2B into a conveyor system 101 of a cathode stripping machine 100 from FIG. 1).

With reference now to FIG. 3B, a perspective view of the chain-install apparatus 300 with the hub assembly 500 removed for clarity (i.e., to provide a more detailed view of the brake assembly 600) is illustrated, in accordance with various embodiments.

With combined reference now to FIGS. 3A and 3B, in accordance with various embodiments, the hub assembly 500 is configured to rotate independently of the hub assembly 501. In this regard, a chain being installed from the hub assembly 500 (e.g., first chain 110 from FIG. 1) can be installed independently from a chain being installed from the hub assembly 501 (e.g., second chain 130 from FIG. 1).

The chain-install apparatus 300 can further comprise a second brake assembly (e.g., brake assembly 601). The brake assembly 601 can be in accordance with the brake assembly 600, as described further herein. Stated another way, the brake assembly 601 and the brake assembly 600 can include the same components as each other. In this regard, each hub assembly (e.g., hub assembly 500, 501) in the chain-install apparatus 300 can have a corresponding brake assembly (e.g., brake assembly 600, 601) configured to control a rate of feed of a chain being installed from the respective hub assembly (e.g., hub assembly 500 or hub assembly 501), as described further herein. For example, the brake assembly 600 is operably coupled to the hub assembly 500. Accordingly, in response to transitioning a driving mechanism of the first brake assembly (e.g., brake input 610 of the brake assembly 600) from a first position to a second position, a brake force applied by the brake assembly 600 to the hub assembly 500 is varied (i.e., increases or decreases), as described further herein.

In various embodiments, the chain-install apparatus 300 can be defined relative to an X-Y-Z coordinate system as shown. A Z-direction for the chain-install apparatus 300 can correspond to a longitudinal direction of the chain-install apparatus. In this regard, a chain being installed by the chain-install apparatus 300 (e.g., first chain 110 and/or second chain 130 being installed into the conveyor system 101 from FIG. 1) can be configured to be fed in the longitudinal direction as described further herein. In various embodiments, an X-direction for the chain-install apparatus 300 can correspond to a lateral direction. In this regard, the lateral direction (X-direction) and the longitudinal direction (Z-direction) of the chain-install apparatus 300 define a horizontal plane (X-Z plane). In various embodiments, a Y-direction for the chain-install apparatus 300 corresponds to a vertical direction. Accordingly, the vertical direction (Y-direction) is perpendicular to the horizontal plane (X-Z plane). As described further herein, longitudinal refers to the Z-direction of the chain-install apparatus 300, lateral refers to the X-direction of the chain-install apparatus 300, and vertical refers to the Y-direction of the chain-install apparatus 300 as illustrated in FIGS. 3A and 3B. In various embodiments, longitudinal can also be in reference to a centerline (or central axis) defined by an aperture.

In various embodiments, the support structure 400 comprises a base 410 and a frame 420. A “base” as referred to herein is any structure that is configured to support the chain-install apparatus 300 in response to the chain-install apparatus being placed on a ground surface. In this regard, the base 410 can include a flat bottom surface configured to interface with a ground surface. Stated another way, the base 410 can include a flat bottom surface that is substantially parallel to the horizontal plane (X-Z plane). A “frame” as referred to herein is any structure that holds various parts of the chain-install apparatus 300 (e.g., the hub assembly 500, the hub assembly 501) in a position and gives the parts support. Although illustrated as the frame 420 including columns (e.g., columns 421, 422, 423) and beams (e.g., beams 424, 425, 426), the present disclosure is not limited in this regard. For example, the frame 420 could include a housing (e.g., enclosing the hub assembly 500 and/or the hub assembly 501) therein, and still be within the scope of this disclosure.

In various embodiments, the base 410 is configured to facilitate lifting of the chain-install apparatus 300 via a forklift. In this regard, the base 410 can be configured to facilitate transportation of the chain-install apparatus around a supplier's facility (i.e., prior to shipping one or more of chain 200 from FIGS. 2A and 2B to be installed in the cathode stripping machine 100 as the first chain 110 and/or the second chain 130 from FIG. 1) and/or to facilitate transportation of the chain-install apparatus around an end user's production facility, as described further herein.

Accordingly, the base 410 can include at least one pair of fork pockets (e.g., fork pockets 411, 412 and/or fork pockets 431, 432). In various embodiments, each fork pocket (e.g., fork pockets 411, 412 and/or fork pockets 431, 432) in the base 410 of the chain-install apparatus can be continuous tubular elements, discontinuous tubular elements, continuous apertures in a solid structure, discontinuous apertures between solid structures, or the like. The present disclosure is not limited in this regard. A “fork pocket” as referred to herein, is an opening in the base 410 configured for insertion of a prong of a forklift. The opening can be a through aperture or a blind aperture. In this regard, the opening of each fork pocket (e.g., fork pockets 411, 412, 431, 432) can extend entirely through the base 410 (e.g., in a lateral direction for fork pockets 431, 432 and in a longitudinal direction for fork pockets 411, 412), in accordance with various embodiments. Although illustrated as extending entirely through the base 410, the present disclosure is not limited in this regard. For example, the fork pockets 411, 412 could each include blind apertures (e.g., a first longitudinal end of the fork pockets 411, 412 could be open and a second longitudinal end could be closed), and still be within the scope of this disclosure.

Although illustrated as having fork pockets in both the lateral direction (i.e., the X-direction) and the longitudinal direction (i.e., the Z-direction), the present disclosure is not limited in this regard. For example, fork pockets can be disposed in one of the lateral direction or the longitudinal direction (e.g., fork pockets 411, 412 or fork pockets 431, 432), and still be within the scope of this disclosure. However, by having fork pockets in both the lateral direction and the longitudinal direction, the chain-install apparatus 300 can be more adaptable for transportation configuration by forklift relative to only having fork pockets in a single direction, in accordance with various embodiments. Stated another way, the chain-install apparatus 300 from FIGS. 3A and 3B could be lifted by a forklift from either longitudinal side of the chain-install apparatus 300 and from either lateral side of the chain-install apparatus 300 (e.g., based on which fork pockets are accessible to the forklift), in accordance with various embodiments.

The fork pockets 411, 412 each include an opening that extends longitudinally (i.e., in the Z-direction) from a first side to a second side of the base 410. In this regard, the fork pocket 411 can be substantially parallel to the fork pocket 412. For example, the opening of the fork pocket 411 can define a central longitudinal axis (e.g., substantially parallel to the Z-direction) and the opening of the fork pocket 412 can define a central longitudinal axis (e.g., substantially parallel to the Z-direction). “Substantially parallel” as referred to herein includes axis that are parallel relative to one another plus or minus 10 degrees, or plus or minus 5 degrees, in accordance with various embodiments.

Similarly, the fork pockets 431, 432 each include an opening that extends laterally (i.e., in the X-direction) from a first side to a second side of the base 410. In this regard, the fork pocket 431 can be substantially parallel to the fork pocket 432. For example, the opening of the fork pocket 431 can define a central longitudinal axis (e.g., substantially parallel to the X-direction) and the opening of the fork pocket 432 can define a central axis (e.g., substantially parallel to the X-direction).

The opening of the fork pocket 411 can be spaced apart laterally (i.e., in the X-direction) from the opening of the fork pocket 412. Stated another way, a central longitudinal axis of the opening of the fork pocket 411 can be spaced apart laterally from a central longitudinal axis of the opening of the fork pocket 412 by a lateral distance. The lateral distance between the central longitudinal axis defined by the opening of the fork pocket 411 and the central longitudinal axis defined by the opening of the fork pocket 412 can be any lateral distance that facilitates receiving a fork from a forklift. In various embodiments, many forklifts are capable of varying a lateral distance between forks. Accordingly, the lateral distance between the opening of the fork pocket 411 and the opening of the fork pocket 412 is not limited in this regard.

Similarly, the opening of the fork pocket 431 can be spaced apart longitudinally (i.e., in the Z-direction) from the opening of the fork pocket 432. Stated another way, a central longitudinal axis of the opening of the fork pocket 431 can be spaced apart from a central longitudinal axis of the opening of the fork pocket 412 by a distance. The distance between the central longitudinal axis defined by the opening of the fork pocket 411 and the central longitudinal axis defined by the opening of the fork pocket 412 can be any distance that facilitates receiving a fork from a forklift. In various embodiments, many forklifts are capable of varying a lateral distance between forks. Accordingly, the distance between the opening of the fork pocket 431 and the opening of the fork pocket 432 is not limited in this regard.

In various embodiments, the chain-install apparatus 300 is operable by an operator (e.g., an operator installing the first chain 110 or the second chain 130 into the cathode stripping machine 100 from FIG. 1) from the base 410. For example, various components configured to facilitate installation and unwinding of chain(s) for installation (e.g., a chain 200 winded on hub assembly 500 and/or a chain 200 winded on hub assembly 501) from the base 410. Stated another way, in response to the chain-install apparatus 300 being transitioned to a lifted state prior to installation, the base 410 can be at about chest level with an operator of the chain-install apparatus 300. Accordingly, by placing various components for operation on the base 410, operation of the chain-install apparatus 300 can be simplified in the lifted state, in accordance with various embodiments.

In various embodiments, the base 410 comprises a first lateral side 413 and a second lateral side 414. The first lateral side 413 can be defined partially by a wall that defines the opening of the fork pocket 411. Similarly, the second lateral side 414 can be partially defined by a wall that defines the opening of the fork pocket 412. Stated another way, the lateral sides 413, 414 can each be at least partially defined by vertical wall that extends from a bottom wall of the base 410 to a top wall of the base 410. In various embodiments, a handle 440 is coupled to the first lateral side 413 of the base. Similarly, a handle in accordance with the handle 440 can be coupled to the second lateral side 414 of the base in a similar manner. In this regard, an operator can stabilize the install chain-install apparatus 300 during installation of a chain (e.g., a chain 200 from FIGS. 2A and 2B winded within a hub assembly 500, 501) during installation of the respective chain, as described further herein. In various embodiments, the handle 440 can be disposed between (e.g., longitudinally between) fork pocket 431 and fork pocket 432. In this regard, the handle 440 can be relatively centered along a longitudinal length of the chain-install apparatus 300 to provide greater stability while the chain-install apparatus 300 is in a lifted state, in accordance with various embodiments.

In various embodiments, chain-install apparatus 300 further comprises a guide corresponding to each hub assembly (e.g., guide 460 for hub assembly 500 and/or guide 461 for hub assembly 501) and coupled to the base 410. Each guide is configured to facilitate a smooth transition of a chain (e.g., chain 200 from FIG. 2) that is being installed from the chain-install apparatus 300 from a lifted state into the conveyor system 101 from FIG. 1. In this regard, each guide is configured to guide a respective chain in a downward direction as described further herein. Accordingly, the guide 460 is coupled to the base 410 at a longitudinal end of the base 410 that defines a feed direction (i.e., a direction for unwinding a chain 200 from FIGS. 2A and 2B that is winded within the hub assembly 500). Similarly, the guide 461 is coupled to the base 410 at the same longitudinal end of the base 410 as the guide 460, spaced apparat laterally from the guide 460, and aligned with the hub assembly 501 in a similar manner to guide 460 being aligned with the hub assembly 500.

In various embodiments, each guide (e.g., guide 460 and/or guide 461) comprises a contoured surface. For example, the guide 460 can comprise a contoured surface 462 that extends from a top edge proximal the hub assembly 500 to a bottom edge distal to the hub assembly 500 and abutting the base 410. Between the top edge and the bottom edge, the contoured surface 462 is defined. The contoured surface 462 can include an arcuate shape. Although being illustrated as a convex surface, the contoured surface is not limited in this regard. For example, the contoured surface 462 could be a concave surface and still be within the scope of this disclosure. Similarly, although each guide (e.g., guide 460 and/or guide 461) are illustrated as including the contoured surface 462, the present disclosure is not limited in this regard. Each guide (e.g., guide 460 and/or guide 461) could include a linear surface, a surface with two walls on either side defining a pocket therein, or the like and still be within the scope of this disclosure. In this regard, each guide (e.g., guide 460 and/or guide 461) can comprise any component capable of guiding a chain (e.g., chain 200 from FIGS. 2A and 2B winded within hub assembly 500 or hub assembly 501) from the hub assembly toward a track (e.g., first track 120 or second track 140 of conveyor system 101 from FIG. 1) for installation, in accordance with various embodiments.

In various embodiments, each brake assembly (e.g., brake assembly 600 and brake assembly 601) includes a brake input (e.g., brake input 610 for brake assembly 600 and/or brake input 611 for brake assembly 601) coupled to the base 410. In this regard, the brake input of each brake assembly (e.g., brake input 610 for brake assembly 600 and/or brake input 611 for brake assembly 601) can be coupled to a top surface of the base 410 to provide easy access to an operator during installation of a chain winded on the respective hub assembly (e.g., hub assembly 500 for brake input 610 and/or brake input 611 for hub assembly 501). In various embodiments, the brake input 610, 611 can comprise a lever (e.g., lever 612) configured to control a braking force of a brake of a respective brake assembly (e.g., brake assembly 600 for brake input 610 and/or brake input 611 for brake input 611) as described further herein. Although illustrated as including a lever 612, 613, the brake input 610, 611 of each respective brake assembly (e.g., brake assembly 600 and brake assembly 601), the present disclosure is not limited in this regard. For example, the brake input 610, 611 can comprise a pedal, a translating rod, an adjustable button, or any other mechanical brake input configured to vary a braking force, in accordance with various embodiments. In various embodiments, the brake input for each respective brake assembly is spaced apart from a respective handle configured for operation with the respective brake assembly. For example, the brake input 610 is spaced apart longitudinally (i.e., in the Z-direction) from the handle 440. Accordingly, an operator can stabilize the chain-install apparatus 300 via the handle 440 while the chain-install apparatus 300 is in a lifted state and control a braking force of the brake assembly 600 by the brake input 610 during installation of a chain (e.g., chain 200 from FIGS. 2A and 2B winded around the hub assembly 500) as described further herein.

In various embodiments, the frame 420 of the chain-install apparatus 300 is coupled to the base 410 and configured to support the hub assembly (or hub assemblies) of the chain-install apparatus 300. In various embodiments, the frame 420 and the base 410 can form a monolithic structure (i.e., the frame 420 and the base 410 can be formed from a single piece of material). However, the present disclosure is not limited in this regard. For example, the frame 420 and the base 410 can be formed from separate distinct components and still be within the scope of this disclosure. Similarly, although the base 410 is illustrated as a monolithic component, the present disclosure is not limited in this regard. The base 410 can be made of separate distinct components and still be within the scope of this disclosure. In various embodiments, by forming the frame 420 and the base 410 as a monolithic component, a part count of the chain-install apparatus can be reduced, in accordance with various embodiments.

In various embodiments, the frame 420 can comprise vertical support structures and lateral support structures. For example, the frame 420 can comprise columns 421, 422, 423, and beams 424, 425, 426. The columns 421 can extend vertically from the base 410 to a top end. The beams 424, 425, 426 can define a top structure of the support structure 400 of the chain-install apparatus. The top structure can be configured to facilitate lifting of the chain-install apparatus. For example, the attachment arrangement 450 can be formed on the top structure (e.g., on a top surface of beam 424 and a top surface of beam 426).

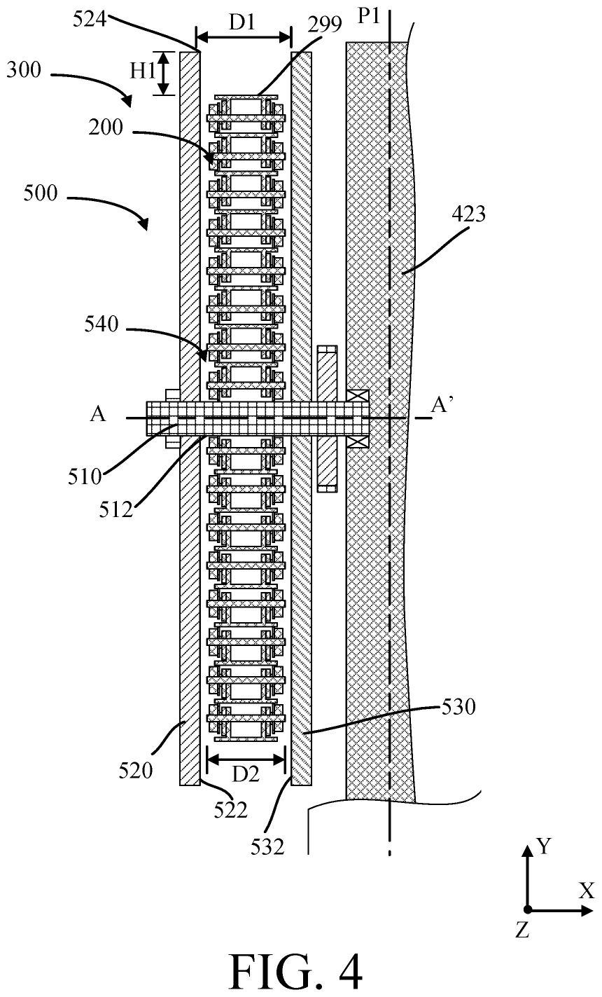

Referring now to FIG. 4, a cross-sectional view of a portion of the chain-install apparatus 300 with the chain 200 winded within the hub assembly 500 is illustrated, in accordance with various embodiments. The cross-sectional view is along a central lateral plane (i.e., X-Y plane from FIGS. 3A and 3B) that is through a central axis A-A′ defined by the shaft 510 of the hub assembly 500. In various embodiments, the hub assembly 501 from FIG. 1 can be in accordance with the hub assembly 500 and mirror the hub assembly 500 about a central longitudinal plane P1 (e.g., a Y-Z plane) extending through the support structure 400 (e.g., through the column 423 of the frame 420). Accordingly, each component described herein with respect to the hub assembly 500 can correspond to the hub assembly 501 from FIGS. 3A and 3B. In this regard, an overall part count for the chain-install apparatus can be reduced, relative to an apparatus that has hub assemblies comprised of different components, in accordance with various embodiments.

In various embodiments, an inner lateral surface 522 of the first guard 520, an inner lateral surface 532 of the second guard 530, and a radially outer surface 512 of the shaft 510 form the pocket 540 configured to receive the chain 200. Although illustrated as radially outer surface 512 of the shaft 510 partially forming the pocket 540, the present disclosure is not limited in this regard. For example, the first guard 520 and the second guard 530 can be formed of a single piece of material or made as a single component that includes a tubular element extending therebetween. In this regard, a radially outer surface of the tubular element between the first guard and the second guard could define the pocket 540 and still be within the scope of this disclosure. The tubular element could then be coupled to the shaft 510 and configured to rotate with the shaft 510, in accordance with various embodiments.

The first guard 520 and the second guard 530 can be spaced apart laterally (i.e., in the X-direction) by a first lateral distance D1. The pocket 540 of the first hub assembly is configured to receive the chain 200 winded therein. The chain 200 defines a second lateral distance D2 from a first lateral side of the chain to a second lateral side of the chain 200. In various embodiments, the lateral distance D2 can correspond to a maximum local lateral distance of the chain 200. In this regard, due to assembly tolerances and manufacturing tolerances, the chain 200 can have different local lateral distances along an entire length of the chain 200. Similarly, the first lateral distance D1 defined between the first guard 520 and the second guard 530 can correspond to a minimum local distance between the inner lateral surface 522 of the first guard 520 and the inner lateral surface 532 of the second guard 530. In various embodiments, the pocket 540 is formed and configured to also guide the chain 200 during an installation of the chain 200 (e.g., installation of the chain 200 into the conveyor system 101 of the cathode stripping machine 100). For example, the first lateral distance D1 can be between 1.01 times and 2 times the second lateral distance D2, or between 1.01 times and 1.75 times the second lateral distance D2, or between 1.01 times and 1.5 times the second lateral distance, or between 1.01 times and 1.25 times the second lateral distance D2. Additionally, in accordance with various embodiments, in response to winding the chain 200 in the pocket 540 of the hub assembly 500, an outer surface 299 of the chain 200 can be spaced apart vertically from a radially outer edge 524 of the first guard 520. In this regard, the pocket 540 can also be configured for lateral retention of the chain 200 during transportation of the chain 200 (e.g., from a supplier warehouse to a production facility where the chain 200 will be installed). Stated another way, the chain 200 can be configured to be retained within the pocket 540 during transport without having to have any additional retention mechanisms for the chain 200 via the configuration of the guards 520, 530 described previously herein.

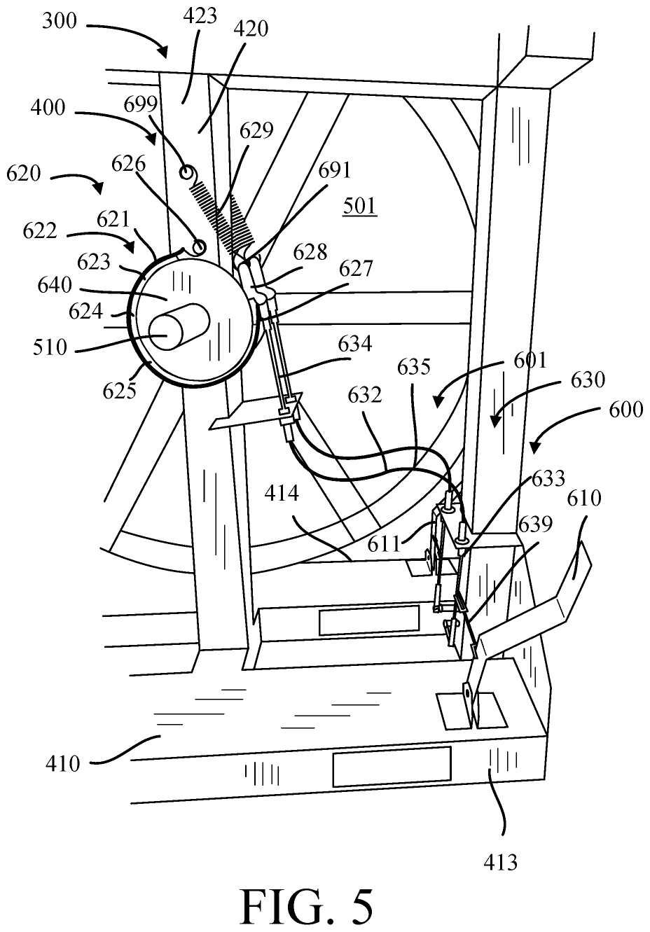

Referring now to FIG. 5, a perspective view of a portion of the chain-install apparatus 300 with the hub assembly 500 removed for illustrative purposes to show the brake assembly 600 and a portion of the brake assembly 601, is illustrated, in accordance with various embodiments. During unwinding of a respective chain (e.g., chain 200 from FIGS. 2A-B) from a respective hub assembly (e.g., the hub assembly 500 from FIGS. 3A, 3B, and 4 for brake assembly 600 and/or hub assembly 501 for brake assembly 601), the brake assembly 600, 601 is configured to control a rate of feed of the chain. Accordingly, as described further herein, the brake assembly 600, 601 can be configured to transition between a default state and a released state. A “default state” as referred to herein is a configuration of the brake assembly 600, 601 where a maximum braking force is applied by a respective brake (e.g., brake 620 for brake assembly 600). A “released state” as referred to herein is a configuration of the brake assembly 600, 601 where the respective hub assembly is configured to spin freely (i.e., there is no brake force from a brake for the brake assembly). In this regard, the brake assembly 600, 601 can be configured for various intermittent configurations where a braking force applied to the respective brake drum, and the corresponding hub assembly, is between the maximum brake force of the default state and no braking force of the released state based on the brake input (e.g., brake input 610 for brake assembly 600 and brake input 611 for brake assembly 601). Accordingly, based on a position of the brake input of a respective brake assembly (e.g., brake input 610 of brake assembly 600), the respective brake assembly is configured to apply a brake force associated with the position.

Although described further herein with respect to brake assembly 600, the present disclosure is not limited in this regard. For example, the brake assembly 601 can include each component in the brake assembly 600 with one of the only differences being the brake assembly 601 is operably coupled to the hub assembly 501, whereas the brake assembly 600 is coupled to the hub assembly 500. Accordingly, for the sake of brevity, brake assembly 600, 601 will be described with respect to brake assembly 600 hereafter.

The brake assembly 600 comprises the brake input 610, the brake 620, and brake linkages 630. The brake linkages 630 are configured to receive an input from the brake input 610 and control an output of the brake 620 in response to the input from the brake input 610. In various embodiments, the brake input 610 can comprise a lever 612. However, as described previously herein, the present disclosure is not limited in this regard, and various other brake inputs (e.g., electronic or mechanical) are within the scope of this disclosure.

In various embodiments, the brake linkage 630 can comprise a push-pull control cable 632. Although the brake linkages 630 are illustrated as including a push-pull control cable 632, the present disclosure is not limited in this regard. For example, the brake linkages 630 can include purely mechanical linkages (i.e., without any electrical component), controllers and sensors operably coupled to the brake input, or the like. Accordingly, the brake linkages 630 can comprise any linkage configured to control (i.e., electronically or mechanically) a brake force applied by the brake 620 in response to receiving an input (e.g., a mechanical input, an electronic input, etc.) from the brake input 610.

The push-pull control cable 632 can comprise a first end 633 operably coupled to the brake input 610 and a second end 634 operably coupled to the brake 620. Stated another way, in response to the first end 633 of the push-pull control cable 632 translating, the second end 634 of the push-pull control cable 632 can be configured to translate also, independently of the first end 633. The push-pull control cable 632 can further comprise an electrical cable 635 extending between the first end 633 and the second end 634. In this regard, the electrical cable 635 can transmit a control signal (e.g., generated in response to translation of the first end 633) to the second end 634 (i.e., to control translation of the second end 634). Although illustrated with an electrical cable 635, the present disclosure is not limited in this regard. For example, the first end 633 of the push-pull control cable 632 could include a transmitter (or transceiver), and the second 634 of the push-pull control cable 632 could include a receiver (or transceiver) and would still be within the scope of this disclosure. Accordingly, the brake linkage 630 disclosed herein is not limited to physical linkages, and control signals transmitted via short range communication devices, as opposed to physical cables, are within the scope of this disclosure. In various embodiments, translation of the second end 634 can be proportional (i.e., on a 1:1 basis) with the first end 633. However, the present disclosure is not limited in this regard. For example, the second end 634 can be configured to translate more or less than the first end 633 (e.g., between 2:1 and 0.5:1) and still be within the scope of this disclosure.

In various embodiments, the brake 620 comprises a band brake 622. Although the brake 620 is illustrated as a band brake 622, the present disclosure is not limited in this regard. For example, the brake 620 can comprise interleaved stators or rotors that are configured to supply a braking force in response to being compressed, the brake 620 can comprise an axial piston configured to contact an axial surface of a brake drum, or the like and still be within the scope of this disclosure.

In various embodiments, the brake assembly 600 further comprises a brake drum 640 operably coupled to the shaft 510 of the hub assembly 500 from FIGS. 3A and 4. In this regard, the brake drum 640 and the shaft 510 are configured to spin (or rotate) together (i.e., about the central axis A-A′ of the shaft 510 as shown in FIG. 4). Accordingly, in response to the brake drum 640 being exposed to a brake force from the brake 620, the hub assembly 500 corresponding to the brake assembly 600 can be slowed or halted, as described further herein. For example, brake input 610 (e.g., the lever 612) can be configured to vary a braking force applied by the brake to the brake drum 640, as described further herein.

The band brake 622 can comprise a brake pad 623 coupled to the brake drum 640. In various embodiments, the brake pad 623 can comprise an arcuate portion 625 extending circumferentially about a central axis of the brake drum 640 (e.g., the central axis A-A′ of the shaft 510 from FIG. 4). In various embodiments, the arcuate portion can extend between 90 degrees and 360 degrees around the central axis A-A′ of the shaft 510 from FIG. 4, or between 180 degrees and 360 degrees around the central axis A-A′ of the shaft 510 from FIG. 4, or between 240 degrees and 300 degrees around the central axis A-A′ of the shaft 510. In various embodiments, the brake pad 623 is configured to protect the brake drum 640 from wear during operation of the chain-install apparatus 300. In this regard, the brake pad 623 can be configured to wear at a significantly slower rate relative to the brake drum 640 in response to being exposed to a circumferential friction (e.g., from operation of the band brake 622), in accordance with various embodiments.

In various embodiments, the brake drum 640, the brake 620, and the brake linkage 630 are disposed laterally (i.e., the X-direction) between the first lateral side 413 and the second lateral side 414 of the base 410. In various embodiments, a joint of the lever 612 can be disposed laterally between the first lateral side 413 and the second lateral side 414. In this regard, by having a majority of the brake assembly 600 disposed laterally within the base 410, the chain-install apparatus 300 can be more compact relative to other brake assemblies for spool type devices, in accordance with various embodiments.

The band brake 622 can further comprise a band 621 fixedly coupled at a first end 626 (e.g., a first circumferent end relative to the central axis A-A′ from FIG. 4) to the support structure 400 (e.g., column 423 of frame 420) of the chain-install apparatus 300 and fixedly coupled at a second end 627 (e.g., a second circumferential end relative to the central axis A-A′ from FIG. 4) to a mount 628. The mount 628 can be operably coupled to the brake linkages 630 and configured to move (e.g., translate) in response to an input from the brake input 610 being adjusted, as described further herein. In various embodiments, a spring 629 can be coupled to the brake 620 (e.g., via mount 628) at a first end 691 of the spring 629 and coupled to the support structure 400 (e.g., the column 423 of the frame 420) at a second end 699 of the spring 629. The spring 629 can be configured to bias the band brake 622 in the default state of the brake assembly 600, in accordance with various embodiments. For example, in response to the brake input 610 being in a default position, as described further herein, the spring 629 can pull the mount 628 toward the second end 699 of the spring 629 that is coupled to the support structure 400. Accordingly, the spring 629 can comprise a tension spring, in accordance with various embodiments. Although illustrated as comprising a tension spring, the present disclosure is not limited in this regard. For example, the band brake 622 could utilize a torsional spring and still be within the scope of this disclosure.

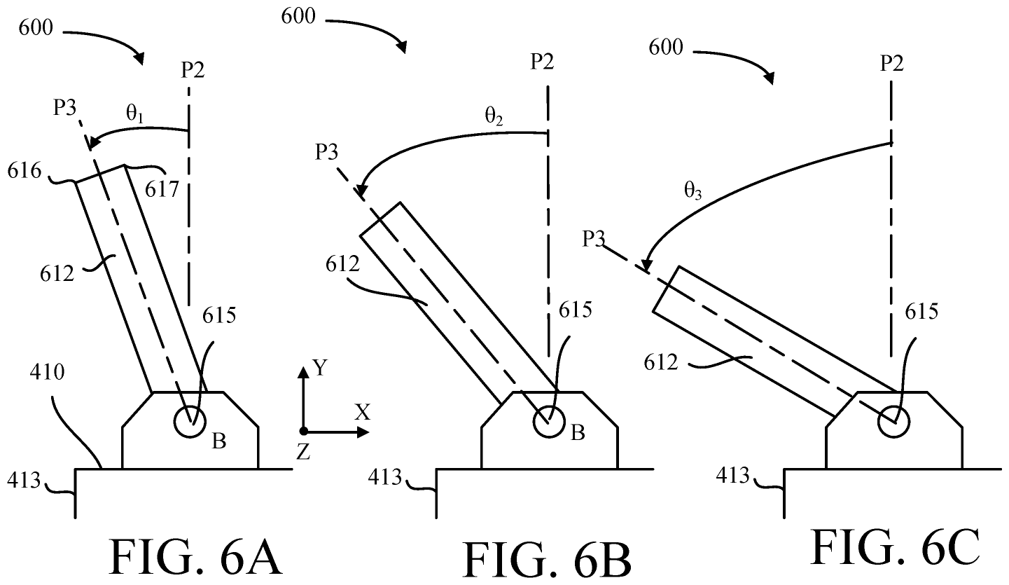

Referring now to FIGS. 6A-C, a side view the lever 612 of the brake input 610, where in response to the lever 612 being in the positions as illustrated, the brake assembly 600 of the chain-install apparatus 300 is in a default state (FIG. 6A), a released state (FIG. 6C), and an intermediate state (FIG. 6B), in accordance with various embodiments.

In various embodiments, a lever angle θ can be defined relative to a vertical plane P2 (e.g., a Y-Z plane) that extends through a centerline of a joint 615 of the brake input 610 and a central lever plane P3 defined as a plane extending through the centerline of the joint 615 and a central point defined between a first lateral outer edge 616 and a second lateral outer edge 617 of the lever 612.

As illustrated in FIG. 6A, the lever 612 can include an initial angle θ₁ relative to the vertical plane P2 toward a respective lateral side that is proximate the lever 612 (e.g., first lateral side 413 for brake assembly 600). In various embodiments, by having the initial angle θ₁ that is non-zero (e.g., non-upright), the lever 612 can be angled toward an operator to provide an easier starting point from a lifted state of the chain-install apparatus 300 from FIG. 1. Stated another way, as the base 410 from FIGS. 3A, 3B, is at around a chest level of an operator during installation of a chain (e.g., chain 200 from FIGS. 2A, 2B), the lever 612 can be easier to pull in response to having the initial angle θ₁ of the lever 612 that is non-zero. However, the present disclosure is not limited in this regard. For example, the initial angle θ₁ could be zero, or angled away from an operator (e.g., away from the proximal lateral side, e.g., lateral side 413 for lever 612) and still be within the scope of this disclosure.

In various embodiments, the brake assembly 600 can be configured for an operational range of braking based on the lever angle θ. For example, the operational range can be between the initial angle θ₁ corresponding to the default state from FIG. 6A and a released angle θ₃ corresponding to the released state from FIG. 6C. In various embodiments, the operational range is less than 90 degrees. For example, as outlined above, the lever 612 may be above a chest height of an operator of the chain-install apparatus 300 from FIGS. 3A, 3B during installation of a chain (e.g., chain 200 from FIGS. 2A, 2B) into a conveyor system 101 of a cathode stripping machine 100 from FIG. 1. Accordingly, having an operational range that is less than 90 degrees may facilitate an ease of operation for an operator during installation of the chain into the conveyor system, in accordance with various embodiments.

In a default state (FIG. 6A), the lever 612 has a lower angle relative to the vertical plane P2 than in a released state (FIG. 6C). In the default state (FIG. 6A), the brake assembly 600 (e.g., the brake 620) applies a maximum brake force to the brake drum 640 from FIG. 5. In contrast, in the released state (FIG. 6C), the brake assembly 600 (e.g., the brake 620) applies no brake force to the brake drum 640. In this regard, in the released state, the hub assembly 500 from FIG. 3A is configured to spin freely as described further herein. In response to being in an intermediate state (FIG. 6B) between the default state (FIG. 6A) and the released state (FIG. 6C), the brake assembly 600 (e.g., the brake 620) applies a force inversely proportional to a lever angle measured from the default state (from FIG. 6A). Stated another way, as the change lever angle Δθ relative to the initial angle θ₁ increases, a brake force applied by the brake 620 decreases. In various embodiments, the brake force can decrease linearly, exponentially, logarithmically, or the like from the maximum brake force in the default state (FIG. 6A) to the released state (FIG. 6C). The present disclosure is not limited in this regard. In various embodiments, the brake force decreases linearly from a maximum brake force in the default state (FIG. 6A) to no brake force in the released state (FIG. 6C).

With combined reference now to FIGS. 5 and 6A-C, in response to an operator pulling the lever 612 laterally outward relative to a central vertical plane (e.g., a Y-Z plane through the chain-install apparatus 300), a force applied by the brake 620 to the brake drum 640 is reduced. For example, by pivoting the lever 612 about the joint 615 of the brake input 610, a clevis 639 in the brake linkages 630 moves, causing mechanical linkages in the brake linkages 630 to move, which moves (e.g., translates) the first end 633 of the push-pull control cable 632. In response to the first end 633 translating, the electrical cable 635 sends a command to the second end 634 of the push-pull control cable 632 to translate the second end 634 (i.e., toward the electrical cable 635 and away from the spring 629). In this regard, the mount 628 coupled to the band 621 translates toward the base 410 of the support structure 400, causing a circumferential pressure supplied by the band 621 to reduce, which in turn reduces the brake force supplied by the brake 620 to the brake drum 640. In various embodiments, the brake force can be continuously reduced until the lever is in the released state of FIG. 6C, where the band 621 of the band brake 622 no longer contacts the brake pad 624, allowing the brake drum 640, and consequently the hub assembly coupled thereto (e.g., hub assembly 500 from FIGS. 3A-B), to rotate freely.

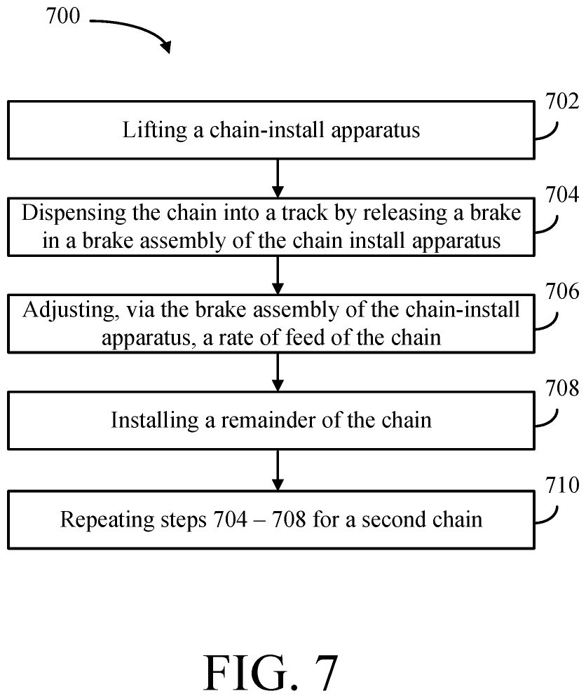

Referring now to FIG. 7, a method 700 of installing a chain (e.g., chain 200 from FIGS. 2A and 2B) to form a conveyor system (e.g., conveyor system 101 of a cathode stripping machine 100 from FIG. 1), is illustrated, in accordance with various embodiments. In various embodiments, the method 700 comprises lifting a chain-install apparatus (step 702), dispensing the chain into the track by releasing a brake of the chain-install apparatus (step 704), adjusting, via a brake assembly of the chain-install apparatus, a rate of feed for the chain during the dispensing the chain (step 706), and installing a remainder of the chain into the track to form the conveyor system (step 708). In various embodiments, the method 700 can further comprise repeating steps 704, 706, and 708 for a second chain (step 710).

With combined reference now to FIGS. 3A, 3B, and 7, step 702 can further comprise coupling a crane to a support structure 400 of the chain-install apparatus 300 (e.g., the attachment arrangement 450 of the support structure 400). In various embodiments, in response to coupling the crane to the attachment arrangement 450, a suspension arrangement can be formed. Coupling the crane to the support structure 400 can further includes coupling a lifting hook to each lifting lug in the plurality of lifting lugs 455. In this regard, based on the attachment arrangement 450 of the support structure 400, the chain-install apparatus 300 can be maneuvered via the crane in a controlled and balanced manner to transition the chain-install apparatus 300 from a ground state (i.e., resting on a ground surface) to a lifted state (i.e., for installation of the chain winded thereon. In various embodiments, in response to performing step 702, the chain-install apparatus 300 would be below a hook of a crane. In this regard, the chain-install apparatus 300 could be classified as a below the hook lifting device in accordance with ASME standard b30.20, as described previously herein.

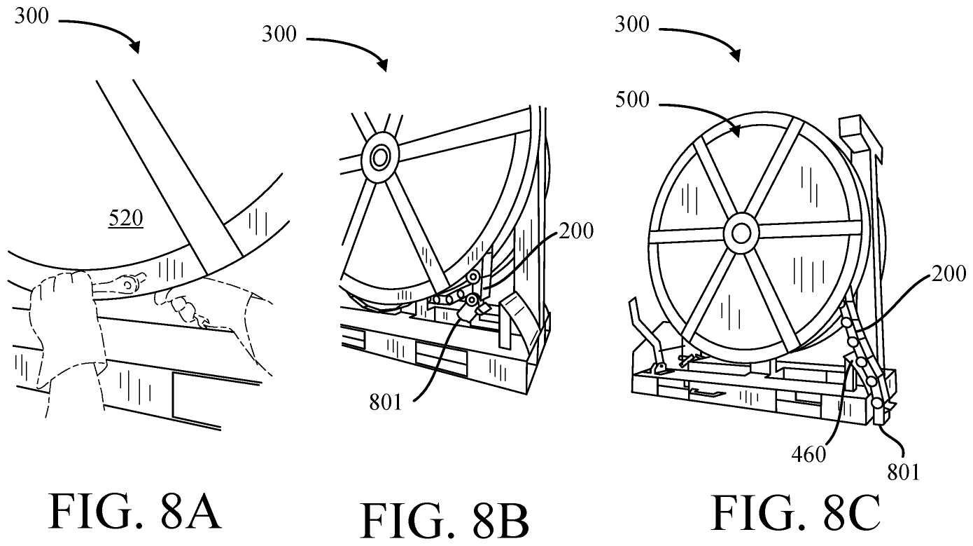

In various embodiments, after the chain-install apparatus 300 is in a lifted state (i.e., after step 702), a fastener that coupled a guide (e.g., guide 460 or guide 461 of the hub assembly 500 from FIG. 3A) to the chain (e.g., chain 200 from FIGS. 2A-B), can be removed as shown in FIG. 8A. In this regard, with brief reference now to FIGS. 8B and 8C, a first longitudinal end 801 of the chain 200 can be de-coupled from the chain-install apparatus 300 to allow the chain 200 to be un-wound from the respective hub assembly 500. After the chain 200 is de-coupled from the chain-install apparatus 300, the first longitudinal end 801 of the chain can be placed on a respective guide corresponding to the hub assembly that the chain is being unwound from (e.g., guide 460 for hub assembly 500). Accordingly, the guide 460 can support a portion of the chain 200 as the chain 200 is being unwound from the hub assembly 500 during the dispensing step (i.e., step 704) of method 700. Stated another way, the chain 200 can be guided by the guide 460 during dispensing of the chain 200 into the track (e.g., track 120 or track 140 of conveyor system 101 from FIG. 1), in accordance with various embodiments.

With combined reference now to FIGS. 5, 6A-C, and 7, the adjusting the rate of feed for the chain in step 706 can further comprise reducing the rate of feed for the chain in response to reducing a lever angle θ of a lever 612 in the brake assembly 600 relative to a vertical plane P2. Similarly, in various embodiments, adjusting the rate of feed for the chain can further comprises increasing the rate of feed for the chain in response to increasing the lever angle θ of the lever 612 in the brake assembly 600.

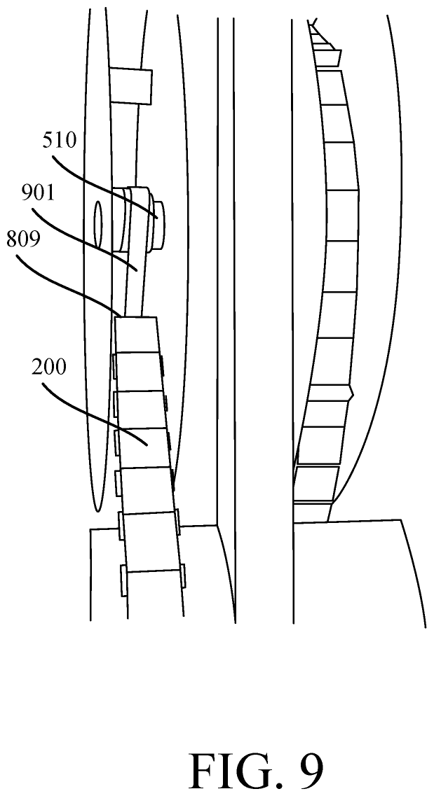

In various embodiments, prior to installing a remainder of the chain in step 708, the method 700 further comprises decoupling the remainder of the chain from the chain-install apparatus 300. For example, with brief reference now to FIG. 9, a second longitudinal end 809 of the chain 200 can be coupled to the hub assembly 500 (e.g., the shaft 510) by a strap 901 or the like. In this regard, the strap 901 can be winded around the shaft 510 in a similar manner to the chain 200 and provide additional slack for the chain 200 to be safely and efficiently de-coupled from the chain-install apparatus 300 prior to installing the remainder of the chain into the track (e.g., track 120 or track 140 of the conveyor system 101 from FIG. 1).

In various embodiments, with reference now to FIGS. 3A, 3B, and 7, steps 704, 706, and 708 can be repeated with the hub assembly 501 (i.e., in response to installing a chain from hub assembly 500 first), to install a second chain (e.g., chain 130 from FIG. 1 in response to installing chain 110 from FIG. 1 initially). In this regard, after step 710, a conveyor system 101 for a cathode stripping machine 100 can be formed. In various embodiments, by installing chains 110, 130 into the conveyor system 101 from FIG. 1 in accordance with the method 700, the chains 110, 130 can be installed in a safe and efficient manner with two operators (i.e., an operator to control the rate of feed via the brake assembly 600 or brake assembly 601 and an operator to guide the chain into the respective track).

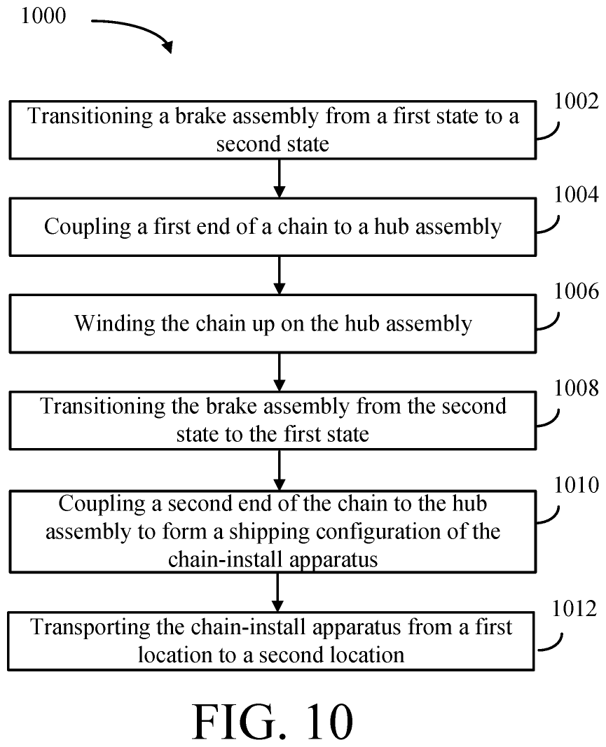

Referring now to FIG. 10, a method 1000 (e.g., a method for preparing and shipping the chain-install apparatus 300 from FIGS. 3A-B), is illustrated, in accordance with various embodiments. The method 1000 can comprise transitioning a brake assembly 500 from a first state (e.g., a default state) to a second state (e.g., a released state) (step 1002). In this regard, in response to being in the first state, the brake assembly can be applying a first braking force to the hub assembly 500 (e.g., a maximum braking force or an intermediate braking force). In response to being in the second state, the hub assembly 500 can be configured to spin freely, as described previously herein.

Accordingly, a chain (e.g., chain 200 from FIGS. 2A-B) for installation in a conveyor system 101 from FIG. 1, can be winded onto the hub assembly 500 since the hub assembly can be spun freely. For example, the method 1000 can further comprise coupling the second longitudinal end 809 of the chain 200 as shown in FIG. 9 to the hub assembly 500 (e.g., a shaft 510 of the hub assembly 500) by a strap 901 (step 1004). In various embodiments, the method 1000 can further comprise winding the chain up on the hub assembly 500 (step 1006). For example, the hub assembly 500 can be rotated (e.g., manually by rotating the hub assembly 500) to wind the chain 200 therein.

In various embodiments, the method 1000 further comprises transitioning the brake assembly from the second state back to the first state (step 1008). In this regard, the brake assembly 500 can be transitioned back to a configuration where a maximum brake force is applied to the brake drum of the chain-install apparatus 300 as described previously herein. By having the brake assembly 500 in the default state, the hub assembly 500 can essentially be locked in place with the chain winded thereon, in accordance with various embodiments.

In various embodiments, after the chain is winded on the hub assembly, a longitudinal end at an outer perimeter of the hub assembly (e.g., longitudinal end 801 in FIGS. 8B and 8C of the chain 200 is coupled to a guard (e.g., guard 520 or guard 530 of the hub assembly 500) (step 1010). In this regard, the chain can be properly secured to the hub assembly 500 prior to shipment.

In various embodiments, the method 1000 further comprises transporting the chain-install apparatus from a first location to a second location (step 1012). In this regard, the chain-install apparatus can be transported via a forklift as described previously herein to transport the chain install-apparatus from a location where the chain was manufactured to a location where the chain is to be installed (i.e., a production facility) or to transport the chain-install apparatus from one area of a production facility to an installation location.

In various embodiments, in the shipping configuration an outer surface of the chain is spaced apart radially from an outer perimeter of the guard as shown in FIG. 4. In various embodiments, in the shipping configuration a vertical distance from a bottom end of the chain to a top end of the chain is less than a diameter of the guard (e.g., guard 520 and/or guard 530 of the hub assembly 500). In this regard, personnel transporting the chain may be able to do so in a safe manner without risk of injury from exposure to pinch points or the like of the chain being transported.

In various embodiments, a chain-install apparatus comprises: a support structure; a first hub assembly coupled to the support structure, the first hub assembly including a shaft, a first guard coupled to the shaft, and a second guard coupled to the shaft, the first guard spaced apart laterally from the second guard and defining a first pocket therebetween; a first brake assembly operably coupled to the first hub assembly; and an attachment arrangement coupled to the support structure.

In various embodiments, the base of the chain-install apparatus of [0101] includes a first opening extending from a first side of the base to a second side of the base, the first opening defining a first central axis, the base includes a second opening extending from the first side to the second side, the second opening defining a second central axis, and/or the first central axis being spaced apart from the second central axis.

In various embodiments, the chain-install apparatus of [0101] can further comprise a guide coupled to the base, the guide configured to guide the chain in a downward direction during installation of the chain.

In various embodiments, the first brake assembly of [0101] further comprises a brake input; a brake; and a brake drum configured to spin with the shaft, the brake drum operably coupled to the brake, the brake input configured to vary a braking force applied by the brake to the brake drum. In various embodiments, the first brake assembly includes a brake linkage operably coupling the brake input to the brake, and the brake input includes a lever.

In various embodiments, the brake linkage of [0104] includes a push-pull control cable.

In various embodiments, the base of the chain-install apparatus of [0101] includes a first lateral side and a second lateral side, the brake drum of [0104] is disposed laterally between the first lateral side and the second lateral side, and a joint of the lever of [0104] is disposed laterally between the first lateral side and the brake drum.

In various embodiments, the chain-install apparatus of [0101] further comprises a spring extending from a first end to a second end, the first end coupled to the support structure, the second end coupled to the brake of [0104].

In various embodiments, the brake of [0104] comprises a band extending circumferentially around the brake drum from a first circumferential end to a second circumferential end, the first circumferential end of the band is coupled to the support structure, and the second circumferential end of the band is coupled to the second end of the spring.

In various embodiments, in response to pulling the lever of [0104] laterally outward from the first lateral side of the base, a force applied by the brake to the brake drum is reduced.

In various embodiments, the lever of [0104] is configured to transition between an initial position and a released position, the initial position defining a first angle relative to a vertical plane, the released position defining a second angle relative to the vertical plane, the second angle being greater than the first angle, a maximum brake force is applied by the brake to the brake drum in the initial position, and the brake drum is configured to spin freely in response to the lever being in the released position.

In various embodiments, the chain-install apparatus of [0101] further comprises a second hub assembly coupled to the frame of the support structure, the second hub assembly including a second shaft, a third guard coupled to the second shaft, and a fourth guard coupled to the shaft, the fourth guard spaced apart laterally from the third guard and defining a second pocket therebetween. In various embodiments, the chain-install apparatus further comprises a second brake assembly operably coupled to the second hub assembly.

In various embodiments, the attachment arrangement of the chain-install apparatus of [0101] includes a plurality of lifting lugs coupled to a top side of the frame.

In various embodiments, a method of installing a chain to form a conveyor system, comprises: lifting a chain-install apparatus; dispensing the chain into the track by releasing a brake of the chain-install apparatus; adjusting, via a brake assembly of the chain-install apparatus, a rate of feed for the chain during the dispensing the chain; and installing a remainder of the chain into the track.

In various embodiments, the chain from the method of [0113] is guided by a guide of the chain-install apparatus into the track in response to dispensing the chain into the track and releasing the brake.

In various embodiments, the method of [0113] further comprises decoupling the remainder of the chain from the chain-install apparatus prior to the installing the remainder of the chain into the track.

In various embodiments, the adjusting the rate of feed for the chain in the method of [0113] further comprises reducing the rate of feed for the chain in response to reducing a lever angle of a lever in the brake assembly relative to a vertical plane, and adjusting the rate of feed for the chain further comprises increasing the rate of feed for the chain in response to increasing the lever angle of the lever in the brake assembly.

In various embodiments, the method of [0113] further comprising coupling a crane to the chain-install apparatus prior to the lifting the chain-install apparatus.

In various embodiments, the coupling the crane to the chain-install apparatus from [0117] further comprises coupling each hook in a plurality of hooks from the crane to a lifting lug in a plurality of lifting lugs from the chain-install apparatus.

In various embodiments, the method of [0113] further comprises decoupling the first end of the chain from a guard of the chain-install apparatus prior to disposing the first end of the chain into the track.

In various embodiments, the method of [0113] further comprising decoupling a strap from a second end of the chain prior to installing the remainder of the chain into the track to form the conveyor system, the strap coupled to a hub assembly of the chain-install apparatus.

In various embodiments, a method, as disclosed herein, comprises: transitioning a brake assembly from a first state to a second state, wherein in response to being in the first state, the brake assembly applies a first braking force to a hub assembly of a chain-install apparatus, and wherein in response to being in the second state, the hub assembly is configured to spin freely; coupling a first end of a chain to the hub assembly; winding the chain up on the hub assembly; transitioning the brake assembly from the second state to the first state; coupling a second end of the chain to the hub assembly to form a shipping configuration of the chain-install apparatus; and transporting, by a forklift, the shipping configuration of the chain-install apparatus from a first location to a second location.

In various embodiments, the second end of the chain from the method of [0121] is coupled to a guard of the hub assembly.

In various embodiments, in the shipping configuration from the method of [0121] an outer surface of the chain is spaced apart radially from an outer perimeter of the guard.

In various embodiments, in the shipping configuration from the method of [0121], a vertical distance from a bottom end of the chain to a top end of the chain is less than a diameter of the guard.

Benefits, other advantages, and solutions to problems have been described herein regarding specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, any of the above-described concepts can be used alone or in combination with any or all the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible considering the above teaching.

What is claimed is:

1. A chain-install apparatus, comprising:
a support structure;
a first hub assembly coupled to the support structure, the first hub assembly including a shaft, a first guard coupled to the shaft, and a second guard coupled to the shaft, the first guard spaced apart laterally from the second guard and defining a first pocket therebetween;
a first brake assembly operably coupled to the first hub assembly; and
an attachment arrangement coupled to the support structure.

2. The chain-install apparatus of claim 1, further comprising a chain that is winded around the first hub assembly within the first pocket, the chain extending from a first end to a second end, the first end coupled to the shaft.

3. The chain-install apparatus of claim 2, wherein:
the first guard and the second guard are spaced apart laterally by a first lateral distance,
the chain includes a second lateral distance from a first lateral side of the chain to a second lateral side of the chain, and
the first lateral distance is between 1.01 times and 2 times the second lateral distance.

4. The chain-install apparatus of claim 2, wherein the second end of the chain is coupled to the first guard.

5. The chain-install apparatus of claim 2, wherein the chain comprises a plurality of chain link segments, each chain link segment coupled to an adjacent chain link segment in the plurality of chain link segments.

6. The chain-install apparatus of claim 5, wherein the chain comprises a set of attachment chain link segments, each attachment chain link segment in the set of attachment chain link segments including an attachment protrusion extending upward from a body of the attachment chain link segment.

7. The chain-install apparatus of claim 6, wherein each attachment chain link segment is separated from an adjacent attachment chain link segment by a set of chain link segments in the plurality of chain link segments.

8. The chain-install apparatus of claim 5, wherein:
the plurality of chain link segments includes a set of inner chain link segments and a set of outer chain link segments, and
a first inner chain link segment in the set of inner chain link segments configured to couple to a first outer chain link segment in the set of outer chain link segments at a first longitudinal end and a second outer chain link segment in the set of outer chain link segments at a second longitudinal end.

9. The chain-install apparatus of claim 5, wherein each chain link segment includes one of a hollow bearing pin chain, a solid bearing pin chain, and a deep link chain.

10. A chain-install apparatus of claim 1, wherein:
the support structure includes a base and a frame;
the first hub assembly is coupled to the frame of the support structure; and
the attachment arrangement is configured to form a suspension arrangement in response to being coupled to a crane.

11. The chain-install apparatus of claim 10, wherein:
the first guard and the second guard are spaced apart laterally by a first lateral distance,
the first pocket of the first hub assembly is configured to receive a chain that is winded therein, the chain defining a second lateral distance from a first lateral side of the chain to a second lateral side of the chain, and
the first lateral distance is between 1.01 times and 2 times the second lateral distance.

12. The chain-install apparatus of claim 11, wherein in response to winding the chain in the first pocket of the first hub assembly, an outer surface of the chain is spaced apart vertically from a radially outer edge of the first guard.

13. The chain-install apparatus of claim 10, wherein the first brake assembly further comprises a brake input configured to control a braking force of a brake of the first brake assembly, the brake input coupled to the base.

14. The chain-install apparatus of claim 13, wherein:
the base includes a first lateral side spaced apart from a second lateral side,
a handle is coupled to the first lateral side of the base,
the brake input is a lever, and
the lever is coupled to a top side of the base and spaced apart longitudinally from the handle.

15. The chain-install apparatus of claim 10, wherein the first brake assembly comprises:
a brake input;
a brake; and
a brake drum configured to spin with the shaft, the brake drum operably coupled to the brake, the brake input configured to vary a braking force applied by the brake to the brake drum.

16. The chain-install apparatus of claim 15, wherein the first brake assembly includes a brake linkage operably coupling the brake input to the brake, and wherein the brake input is a lever.

17. The chain-install apparatus of claim 10, further comprising a second hub assembly coupled to the frame of the support structure, the second hub assembly including a second shaft, a third guard coupled to the second shaft, and a fourth guard coupled to the shaft, the fourth guard spaced apart laterally from the third guard and defining a second pocket therebetween.

18. The chain-install apparatus of claim 17, wherein the first hub assembly is configured to rotate independently of the second hub assembly.

19. A method of installing a chain to form a conveyor system, the method comprising:
lifting a chain-install apparatus;
dispensing the chain into a track of the conveyor system by releasing a brake of the chain-install apparatus;
adjusting, via a brake assembly of the chain-install apparatus, a rate of feed for the chain during the dispensing the chain; and
installing a remainder of the chain into the track.

20. A method, comprising:
transitioning a brake assembly from a first state to a second state, wherein in response to being in the first state, the brake assembly applies a first braking force to a hub assembly of a chain-install apparatus, and wherein in response to being in the second state, the hub assembly is configured to spin freely;
coupling a first end of a chain to the hub assembly;
winding the chain up on the hub assembly;
transitioning the brake assembly from the second state to the first state;
coupling a second end of the chain to the hub assembly to form a shipping configuration of the chain-install apparatus; and
transporting, by a forklift, the shipping configuration of the chain-install apparatus from a first location to a second location.
